(19) United States
(12) Patent Application Publication
(10) Pub. No.: US 2007/0003725 A1
(43) Pub. Date: Jan. 4, 2007

(54) Tabbed container seal and method of manufacture

(76) Inventor: Paul E. Yousif, Wheaton, IL (US)

Correspondence Address: OLSON & HIERL, LTD., 20 NORTH WACKER DRIVE, 36TH FLOOR, CHICAGO, IL, 60606, US

(21) Appl. No.: 11/173,410

(22) Filed: Jun. 30, 2005

(51) Int. Cl. B32B 33/00

(52) U.S. Cl. 428/40.1; 428/195.1; 428/43

(57) ABSTRACT

An improved container seal comprises a flexible sealant sheet and a flexible tab sheet bonded thereto. The sealant sheet and tab sheet are of the same size and shape. The sealant sheet has a sealing surface and a first thermoplastic surface, and the tab sheet has an outer surface and a second thermoplastic surface. The first and second thermoplastic surfaces are in opposed, congruent contact with each other, and a portion of the first thermoplastic surface is ultrasonically welded to an opposed portion of the second thermoplastic surface. The ultrasonically welded portions of the thermoplastic surfaces are positioned on the sealant sheet and tab sheet in a manner that allows at least one edge portion of the tab sheet to be lifted away from the sealant sheet, providing a tab member for removing the seal from a container.

### FIELD OF THE INVENTION

The invention relates to improved container sealing materials and methods of manufacture thereof. More particularly, the invention relates to improved container seals having a tab member ultrasonically welded to the seal for removing the seal from a container, and methods of manufacturing the tabbed container seals.

### BACKGROUND OF THE INVENTION

Ultrasonic welding is a bonding process used extensively for bonding plastic materials to one another. Application of concentrated, directed sound waves in the ultrasonic frequency range (i.e., about 10,000 to about 70,000 kiloHertz) to a pair of compatible (i.e., physically and chemically similar) thermoplastic materials in contact with one another leads to a fusion of the contacting surfaces of the thermoplastic materials to form a bond that approaches the intrinsic strength of the individual materials themselves.

In a typical ultrasonic welding process, a vibrating metal tool, typically referred to as a “horn”, is placed over a region where two compatible thermoplastic materials are in contact. One of the thermoplastic materials rests against a relatively high mass substrate, such as a plate or roller, typically referred to as an “anvil”, while the horn is held over the other material opposite the anvil, which acts as a reflector to locally concentrate the energy of the ultrasonic waves in the materials in the region immediately between the anvil and the horn. The horn vibrates at ultrasonic frequencies and the sound waves are transmitted to the thermoplastic materials, either through the air or by direct contact of the horn with the materials. The vibrational energy from the sound waves forces the thermoplastic materials to fuse. The distance between the horn and the thermoplastic materials, the vibrational frequency of the horn, and the thermal properties (e.g., melting point, glass transition temperature, and the like) of the thermoplastic materials can be used to vary the strength of the bond that is formed. Inclusion of raised or depressed areas on the anvil helps to concentrate the ultrasonic energy in the region of the materials over the rased portion of the anvil. This typically results in a stronger weld than that obtained with a uniform “flat” anvil. In some applications the horn is momentarily brought into contact with the materials (referred to as the “plunge method”), whereas in many other applications the horn does not contact the materials at all.

Ultrasonic welding can be applied to moving webs of two compatible thermoplastic materials using a fixed position, vibrating horn and a roller as the anvil. For example, fabrics of thermoplastic fibers and/or thermoplastic films or sheets can be bonded together to form a laminate. If the anvil is provided with locally raised areas on its surface, as described above, such as an array of bars or nubs, an array of intermittent ultrasonic spot-welds can be provided between the materials. This technique has been used to form a two-layer, quilted fabric, such as is frequently used for disposable hospital gowns and diapers. Similarly, use of a narrow roller with projecting teeth as the anvil provides a linear array of spot-welds to thermally “stitch” two thermoplastic sheets together, in a pattern similar to sewn stitches, but without the use of thread and complex sewing machine mechanisms.

Ultrasonic welding provides a relatively strong bond between thermoplastic materials without clamping or firmly pressing the materials together. Simple contact between materials is sufficient for ultrasonic bonding to take place. Because ultrasonic welding typically involves using an array of localized welds, the overall thickness of the bonded thermoplastic materials is generally maintained in the regions adjacent to welded regions. In contrast, direct thermal bonding of thermoplastic materials generally requires the materials to be clamped or firmly pressed together with significant force for bonding to occur. In the case of laminated sheet materials, the resulting thermally bonded region can be significantly thinner over a larger area than the combined thickness of the two materials compared to ultrasonic welds of the same strength and distributed over the same surface area. Thus, ultrasonically bonded materials generally can be prepared with less deformation of the materials than is obtained with thermal bonding. Ultrasonic bonding also requires less energy, over all, than thermal bonding to afford bonds of similar strength.

Preferably, ultrasonic welding is performed with a patterned anvil, such as an anvil having an array of raised nubs, raised bars, or a combination thereof, usually arranged in a pattern on the anvil. The resulting ultrasonic weld has a pattern of strongly bonded portions, corresponding to regions where there was a raised structure on the anvil, along with non-bonded, or weakly bonded regions interspersed with the strongly bonded portions. Such patterned welds are stronger than smooth, uniform welds achieved with a flat anvil.

Ultrasonic welds also avoid excessive melting of layers that typically occurs with conventional thermal bonding processes, particularly when a patterned anvil is used. The publication Ultrasonic Plastics Assembly published by Branson Sonic Power Co., Danbury, Conn., (1979), the disclosures of which are incorporated herein by reference, provides an overview of ultrasonic welding as applied to polymeric materials.

It is common practice to seal a container with a sheet material, such as paper, a polymeric film, aluminum foil, or a laminate of paper, polymeric film and/or aluminum foil. The use of such seals, in many cases, has been imposed on the packaging industry by FDA regulations, as a protection against product tampering. Such seals can provide evidence of product tampering, since they are typically destroyed by the process of removing the seal. It is also common to line the inner surface of container closures with a moderately compressible material, such as a polymeric material, pulp board, or a multilayer laminated combination thereof. When a closure containing the liner material is secured to the finish of a container, such as by applying a torque force to a threaded closure that is engaged with a threaded container finish, the resulting pressure exerted by the closure onto the liner, which is interposed between the closure and the container finish, produces a substantially liquid and/or gas-tight seal. When the closure is removed from the container, the liner remains within the closure. Re-engaging the closure with the container finish reestablishes the seal. Liner materials can utilize a pulp or paper substrate or polymeric materials, such as polyolefin foams or laminated multilayer lining materials comprising a combination of pulp or a polymeric foam along with a polymeric film, metal foil, and the like.

In a typical application, closures for containers are lined with a laminated material having a layer of pulp mounted to a layer of aluminum foil by an intermediate wax layer. Such laminated materials also frequently contain a layer of polymer, such as a polyester film, fixed by an adhesive to the foil, and a layer of heat-sealable polymer fixed by an adhesive to the polyester film. The laminate is produced and shipped in roll form, which is then cut to the required shape and size, and mounted in a closure with an adhesive or by friction.

In use, the resulting lined closure is torqued onto a container, such as a bottle or jar, which has been filled with a fluid or solid product. Next, the capped container is passed through a high frequency induction heating unit. During induction heating, radio frequency energy heats the aluminum foil to a temperature in excess of about 65° C., generally about 150° C. or greater. The resulting heat melts the wax in the layer between the pulp and aluminum foil. The melted wax is absorbed by the pulp, causing the pulp to separate from the remainder of the material. The sealing material typically is selected to match the material of construction of the container, and is heat-welded (i.e., heat-sealed) to the finish of the container (i.e., the rim around the access opening of the container) utilizing the heat generated from the induction heating of the aluminum foil. Alternatively, the seal can be affixed over the access opening of a container by an adhesive, in which case the sealing material need not be a heat-sealable polymer, and the container is sealed without recourse to induction heating. When a consumer removes the closure from the container, the pulp layer remains in the closure as a liner, leaving the laminated combination of foil, polymer film, and sealing material over the access opening of the container as seal, to provide evidence of tampering and/or to prevent leakage and contamination of the container contents during storage and shipment. To access the contents of the container, the consumer must pierce the seal to remove it from the container.

Other conventional container seals have a die-cut tab extending beyond the limits of the container finish, so that a consumer can grasp the tab and pull the seal off of the container. When a closure is included over the seal, the tab is folded over the side of the container finish, between the threads of the closure and of the container finish. When such tabs are induction sealable, they include a metal foil layer and have a heat-sealable polymer layer on their underside. During the induction sealing process the tab can become sealed to the threaded side of the container finish, which is generally undesirable. Alternatively, such tabs can be folded up over the seal to that the tab is sandwiched between the closure and the seal. In this arrangement, the tab can become sealed to the closure, which is also undesirable. In addition, the shape of the tab can adversely influence the induction sealing of the seal to a container finish. For example, William Zito, in the article entitled “Does Frequency Matter? Comparing Efficiency of Induction Sealers” in Food and Drug Packaging, 1986, reports that the bond between the container finish and the seal is generally weaker in the area where the tab is present relative to the seal along the remainder of the finish. The variability in bonding strength of the seal around the container finish can lead to leakage problems at the weaker point near the tab. An example of a die-cut tabbed container seal are described in U.S. Pat. No. 4,778,698 to Ou-Yang.

Other container seals include a tab element constructed from one or more folds in one of the layers of the laminated seal. Such folded-tab or “z-tab” structures are produced by laminating a sheet material having pleats or folds onto a flat sheet of material, so that the folded portion can act as a tab when a container seal is cut from the material in register with the folds. The folded portion of the seal is considerably thicker than the remainder of the seal, leading to uneven pressure on the seal at the container finish (i.e., higher pressure at the folds and lower pressure at the unfolded portions). This can lead to uneven bonding and possible seal failure. More even seals can be obtained when the folded layer is kept as thin as possible, however thin folds have a tendency to tear away from the seal upon removal. An example of such a folded tab seal is described in U.S. Pat. No. 4,934,544 to Han. Folded tab structures are complicated to manufacture and have not been readily accepted in the marketplace.

Still other container seals have a lift-tab structure formed via zoned partial lamination of flat two sheet materials, or by including a non-bondable tape in zones between laminated areas. When a container seal is cut in register with the tapes or non-bonded zones at the edge of the seal, the non-bonded or taped portion is liftable from the remainder of the seal forming a tab to aid in removal of the seal from a container. It is common for such partial laminates to tear off or delaminate the seal upon removal, rather than providing a clean removal of the seal from the containers.

The tabbed container seals of the present invention overcome the deficiencies of the conventional tabbed seals by providing a container seal having a tab member ultrasonically welded to a portion of a sheet of sealing material. The seals of the present invention have a more uniform thickness and superior bonding strength between the tab member to the sealing sheet compared to conventional tabbed container seals.

### SUMMARY OF THE INVENTION

The present invention provides an improved container seal having a tab member ultrasonically welded to the seal to facilitate removal of the seal from a container. The tabbed container seal comprises a flexible sealant sheet and a flexible tab sheet bonded thereto. The sealant sheet and tab sheet are of the same size and shape. The sealant sheet has a sealing surface and a first thermoplastic surface, and the tab sheet has an outer surface and a second thermoplastic surface that is ultrasonically welded to the first thermoplastic surface of the sealant sheet. The first and second thermoplastic surfaces are in opposed, congruent contact with each other, and a portion of the first thermoplastic surface is ultrasonically welded to an opposed portion of the second thermoplastic surface. The ultrasonically welded portions of the thermoplastic surfaces are positioned on the sealant sheet and tab sheet in a manner that allows at least one edge portion of the tab sheet to be lifted away from the sealant sheet, providing a tab member for removing the seal from a container.

In use, a tabbed container seal of the invention is sealed over the access opening of a container by adhesively or thermally sealing the sealing surface of the sealant sheet onto the container finish (i.e., onto the rim surrounding the access opening) to seal the opening. The tab member is accessible on top of the seal, so that a consumer can readily grasp the tab member and pull the seal off of the container opening to access the contents of the container.

The container seals of the present invention provide a seal that is simpler to manufacture and more reliable seal removal mechanism than conventional tabbed seals. In particular, the ultrasonic weld bonding of the tab sheet to the sealant sheet provides for more uniform overall thickness in the tabbed seal than is achievable in conventional products, since there is no need for folding of layers or for using partial lamination, taping or partial layers in the seal/tab structure, all of which lead to non-uniform overall thickness in the tab region relative to the rest of the seal, and the resultant problems associated therewith (e.g., non-uniform inductive sealing, tearing or delamination of the seal during removal, and the like). In addition, the ultrasonic welds between the tab sheet and the sealant sheet of the container seals of the invention provide a stronger bond between the tab member and sealing sheet than that obtainable by conventional lamination techniques. As a result, the seals of the present invention have improved tear resistance during opening, while still allowing for a strong bond between the seal and the container finish, compared to conventional tabbed seals.

### BRIEF DESCRIPTION OF THE DRAWINGS

In the Drawings,

FIG. 1 shows a perspective view of a tabbed container seal having an ultrasonically welded portion running through a diameter of the seal.

FIG. 2 is a side view of the tabbed container seal of FIG. 1 showing the tab members lifted away from the sealing sheet.

FIG. 3 shows a perspective view of the tabbed container seal if FIG. 1 is sealed to a container finish.

FIG. 4 is a top view illustration of a laminated sheet of sealing material having two ultrasonically welded bands running along the length of the sheet and showing a die-cutting pattern for cutting tabbed container seals of the invention from the sheet.

FIG. 5 illustrates a portion of an apparatus for manufacturing an ultrasonically welded laminate. Panel A shows an anvil and horn assembly of an ultrasonic welding apparatus. Panel B illustrates a dual web of thermoplastic sheet materials passing between the anvil and horn assembly of Panel A to form an ultrasonically welded laminated sheet material.

FIG. 6 is a top view illustration of a laminated sheet of sealing material having an ultrasonically welded band running along the length of the sheet and showing a die-cutting pattern for cutting tabbed container seals of the invention from the sheet.

FIG. 7 is a perspective view of a container seal of the invention from FIG. 6 sealed to a container finish.

FIG. 8 is a top view illustration of a laminated sheet of sealing material having an ultrasonically welded band running along the length of the sheet and showing a die-cutting pattern for cutting tabbed container seals of the invention from the sheet.

FIG. 9 is a perspective view of a container seal of the invention sealed to a container finish.

FIG. 10 schematically illustrates the layer arrangement of a preferred tabbed container seal of the invention having a tab sheet consisting of a single layer of material and a sealant sheet consisting of 4 layers of material.

FIG. 11 schematically illustrates the layer arrangement of a preferred tabbed container seal of the invention having a tab sheet consisting of a single layer of material and a sealant sheet consisting of 5 layers of material.

FIG. 12 schematically illustrates the layer arrangement of a preferred tabbed container seal of the invention having a tab sheet consisting of a single layer of material and a sealant sheet consisting of 6 layers of material.

FIG. 13 schematically illustrates the layer arrangement of a preferred tabbed container seal of the invention having a tab sheet consisting of 3 layers of material and a sealant sheet consisting of 6 layers of material.

FIG. 14 schematically illustrates the layer arrangement of a preferred tabbed container seal of the invention having a tab sheet consisting of 5 layers of material and a sealant sheet consisting of 7 layers of material.

FIG. 15 schematically illustrates the layer arrangement of a preferred tabbed container seal of the invention having a tab sheet consisting of a single layer of material and a sealant sheet consisting of 9 layers of material.

FIG. 16 illustrates a portion of an apparatus for manufacturing an ultrasonically welded laminate having a band of relatively strong ultrasonic welds flanked by bands of relatively weak, frangible ultrasonic spot-welds. Panel A shows an anvil and horn assembly of an ultrasonic welding apparatus. Panel B illustrates a dual web of thermoplastic sheet materials passing between the anvil and horn assembly of Panel A to form an ultrasonically welded laminated sheet material.

FIG. 17 shows a die-cutting pattern for cutting container seals of the invention from the welded laminate of sheet materials formed as shown in FIG. 16.

FIG. 18 shows the cut container seal of FIG. 17 bound over the access opening of a container, with its tab member temporarily tacked to the sealant sheet.

FIG. 19 illustrates that the weak spot-welds of the container seal of FIG. 18 are readily broken by grasping an edge of the tab member and lifting it from the surface of the underlying sealant sheet by weak ultrasonic spot-welds.

### DETAILED DESCRIPTION OF PREFERRED EMBODIMENTS

As used herein, the term “closure” and grammatical variations thereof, refers to a lid or cap, such as a threaded cap, a lug-type cap, a snap-cap, and the like, that is designed to be repeatedly secured to and removed from a container finish, such that when the cap or lid is secured to the container finish, a seal is formed that protects the contents of the container from contamination and leakage.

The terms “lining material” and “liner” refer to a sheet material that is compressible and preferably semirigid, and is suitable for use within a closure to provide a resealable seal between the closure and a container finish. The term “liner” also refers to a section of lining material that has been cut to fit snugly within a closure against the upper inside surface thereof.

The term “seal” refers to a film or multilayer laminate material that is adhesively secured or heat-sealed over the finish of a container to provide an air and/or fluid tight seal. To access the contents of the container, the seal must be broken. A seal can provide evidence of product tampering, for example, when removal of the seal leaves a residue on the finish of the container. A container is typically is fitted with a closure over a container seal. The closure protects the integrity of the seal during shipping and storage. Closures typically include a liner so that after the container seal is removed, the closure can be put back on the container to protect the contents that may remain in the container.

The term “wax”, as used herein and in the appended claims is not limited to natural waxes and paraffins, but also encompasses materials commonly referred to as waxes in the packaging and converting industries, such as microcrystalline wax, polyethylene wax, polyisobutylene resins, and so-called synthetic waxes (e.g., amide waxes), as well as mixtures thereof.

As used herein and in the appended claims, the term “thermoplastic” refers to a flexible polymeric material that reversibly softens and flows upon application of heat and pressure to the material. Two thermoplastic materials in contact with one another can be bonded together without the use of an adhesive by application of heat and pressure to the two materials or by means of ultrasonic welding.

The term “ultrasonic welding” as used herein and in the appended claims refers to a process whereby two thermoplastic materials in contact with one another are bonded together by application of concentrated ultrasonic frequency sound waves. The term “ultrasonic weld” as used herein and in the appended claims refers to a bonded portion of two thermoplastic materials created by an ultrasonic welding process. Relatively “strong” ultrasonic welds are characterized by a weld bond strength substantially equal to or exceeding the internal cohesive strength of the individual thermoplastic materials that are bonded together. A relatively “weak” ultrasonic weld is characterized by a weld bond strength that is substantially weaker than the internal cohesive strength of the individual thermoplastic materials that are bonded together. As described herein, relatively weak ultrasonic welds are frangible and can be broken by pulling the thermoplastic materials apart or by applying a shearing force to the welds, thereby separating the thermoplastic materials without substantially tearing the individual thermoplastic materials.

As used herein and in the appended claims, the term “laminate” refers to a composite sheet material comprising at least two layers of individual sheet materials, films or coatings. The layers can be adhesively secured to one another, directly bonded to one another, or can be secured to one another by any combination of adhesive and direct bonding. When used as a verb, the term “laminate” and grammatical variations thereof, refers to the process of bonding sheet materials together in a stack (i.e., lamination).

The term “directly bonded” and grammatical variations thereof, as used herein and in the appended claims refers to a physical or chemical bond between two sheet materials, which is achieved without the use of an adhesive. For example, a coating of one polymeric material onto a polymeric film web is a directly bonded laminate. Similarly, ultrasonically welded sheet materials are directly bonded to one another.

For convenience, the term “sheet material” and grammatical variations thereof, is used herein and in the appended claims to refer to any flexible material, which has a thickness that is substantially smaller in comparison to its length and breadth, and encompasses multilayer materials, as well as individual layers of sheets, films, coatings, foils, and the like, regardless of their thickness, and regardless of whether the layer was formed in situ by a coating process or was a preformed sheet or film.

A container seal of the invention comprises a flexible sealant sheet and a flexible tab sheet bonded thereto. The sealant sheet and tab sheet are of the same size and shape. The sealant sheet has a sealing surface and a first thermoplastic surface, and the tab sheet has an outer surface and a second thermoplastic surface that is ultrasonically welded to first thermoplastic surface of the sealant sheet. The first and second thermoplastic surfaces are in contact in an opposed, congruent relationship to each other, and a portion of the first thermoplastic surface is ultrasonically welded to an opposed portion of the second thermoplastic surface. The ultrasonically welded portions of the thermoplastic surfaces are positioned on the sealant sheet and tab sheet in a manner that allows at least one edge portion of the tab sheet to be lifted away from the sealant sheet. The non-bonded portions of the tab sheet provide a tab member for removing the seal from a container. The sealant sheet and the tab sheet can each independently comprise a single layer of material or multiple layers of material laminated together in a stack.

Optionally, a compressible sheet of lining material can be tacked to the outer surface of the tab sheet by a layer of releasable adhesive, such as a layer of wax or like expedient. The resulting integrated liner and container seal can be utilized to seal a container and line a closure for the container, as well.

In one embodiment, the present invention provides a method of manufacturing a tabbed container seal. The method comprises forming at least one ultrasonically welded band between a first moving web of flexible thermoplastic sheet material and a second moving web of flexible thermoplastic sheet material. The first and second webs of thermoplastic material move at substantially the same speed and in the same direction. At least one ultrasonically welded band runs in the direction in which the first and second webs of thermoplastic sheet material are moving, thereby producing a flexible multilayer sheet material including at least one ultrasonically welded band and a substantially non-bonded band running parallel to the at least one ultrasonically welded band on each side thereof. A tabbed container seal is cut from the multilayer sheet material (e.g., with a circular die) in a manner such that a portion of the container seal encompasses a portion of an ultrasonically welded band, and at least one edge portion of the container seal encompasses a portion of a non-bonded band. Optionally, one or more layers of flexible sheet material can be laminated to one or both outer surfaces of the flexible sheet material prior to cutting the container seal from the multilayer sheet material. The container seal includes a tab member formed by the non-bonded portion of the seal. In use, the sealing surface of the container seal is bound to the finish of a container over the access opening of the container. The tab member is liftable from the underlying sealant sheet that is bound to the container finish. A consumer can grasp the tab member and pull the container seal off of the container to access the contents sealed therein.

The sealant sheet, the tab sheet, and the liner, if present, can each independently comprise one or more layers of material, such as cellulose pulp, paper, a synthetic fabric, a polymer film, a polymer foam, a metal foil, and the like, or any combination thereof, the layers being stacked and bound together to form a laminate material. Preferably, at least one of the sealant sheet, the tab sheet, and the liner includes a layer of metal foil, such as aluminum foil. The sealing surface of the sealant sheet preferably comprises a heat-sealable polymer film for heat-bonding to a container finish.

A sealed container of the present invention comprises a container having an access opening surrounded by a container finish. The container includes a seal over its access opening. The seal comprises a container seal of the invention, the sealant sheet of the container seal being bound to the finish over the access opening of the container. The tab member of the container seal provides a mechanism for removing the seal from the container.

In one embodiment, the sealed container also comprises a closure secured to the container finish over the tab sheet of the container seal. Preferably, the closure includes a liner in contact with the tab sheet. The liner preferably is adhesively secured within the closure. In some embodiments the liner is tacked to the outer surface of the tab sheet by a layer of releasable adhesive. When a consumer removes the closure from the container, the liner, which is bound to the closure, shears away from the tab sheet, breaking the adhesive bond between the liner and the tab sheet. The tab sheet remains intact and bound to the sealant sheet. The consumer can then remove the seal from the container by grasping the tab member and pulling the seal away from the container finish. In some embodiments, a visible residue or portion of the sealing sheet remains bound to the rim of the container finish providing an indication that a seal was once bound over the access opening, for example as evidence of tampering, if the seal is removed prior to purchase of the container by the consumer. The liner and container seal can be applied to the sealed container as a single integrated unit by tacking the liner to the tab sheet of the container seal, as described herein.

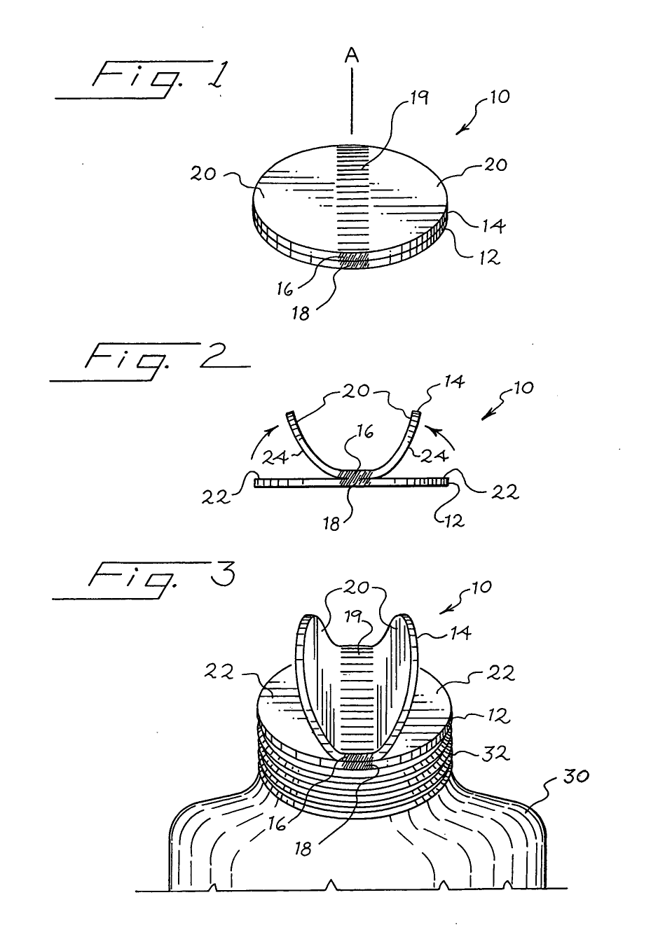

Referring now to the Drawings, wherein similar reference-numbers refer to correspondingly similar components, FIG. 1 schematically illustrates tabbed container seal 10 of the present invention. Tabbed container seal 10 comprises flexible sealant sheet 12 and flexible tab sheet 14 in congruent opposed contact with each other. A portion 16 of tab sheet 14 is ultrasonically welded to an opposed portion 18 of sealant sheet 12 by band of parallel ultrasonic line-welds 19. Non-bonded regions flanking line-welds 19 form tab members 20.

FIG. 2 shows a side view of tabbed container seal 10 with tab members 20 raised away from sealant sheet 12, along diameter line A of FIG. 1. Sealant sheet 12 has a first thermoplastic surface 22 ultrasonically bonded to second thermoplastic surface 24 of tab sheet 14 at portions 16 and 18, respectively. The ultrasonically bonded portions 16 and 18 of tab sheet 14 and sealant sheet 12, respectively, each encompass about 5 to about 25 percent of the area of their respective sheets, preferably about 10 percent, and are approximately centered along a diameter line A of container seal 10.

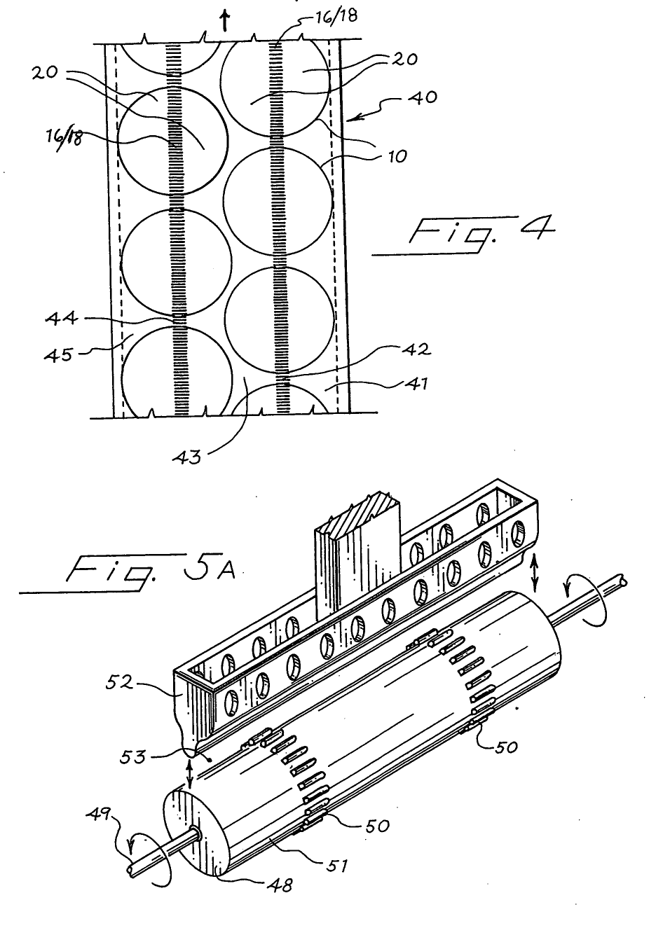

FIG. 3 illustrates tabbed container seal 10 bound over the finish 32 of container 30 providing a seal therefor. Tab members 20 provide a gripping surface for removing container seal 10 from finish 32 to allow access to contents that may be present in container 30. As shown in FIG. 1 and FIG. 3, the ultrasonically welded portions 16 and 18 comprise discrete, spaced line-welds 19 arranged in a parallel pattern within zones 16 and 18. The spaced pattern of welds 19 provides superior strength compared to a continuous, uniform weld encompassing the entire surface areas of portions 16 and 18.

FIG. 4 illustrates a layout for manufacturing a tabbed container seal of the invention, such as container seal 10, from a roll of multilayer laminate 40. Multilayer laminate 40 includes ultrasonically welded bands 42 and 44 and non-bonded regions 41, 43, and 45 running along the length of laminate 40 in the direction of the web movement indicated by the arrow, flanking bands 42 and 44. Ultrasonically welded bands 42 and 44 are arranged across laminate 40 so that two rows of die-cut container seals 10 can be cut from laminate 40 to provide an ultrasonically welded band 16/18 extending through the diameter of each seal 10. Non-bonded zones 41, 43, and 45 are arranged across web 40 so that die-cut container seals 10 each include two non-bonded tab members 20.

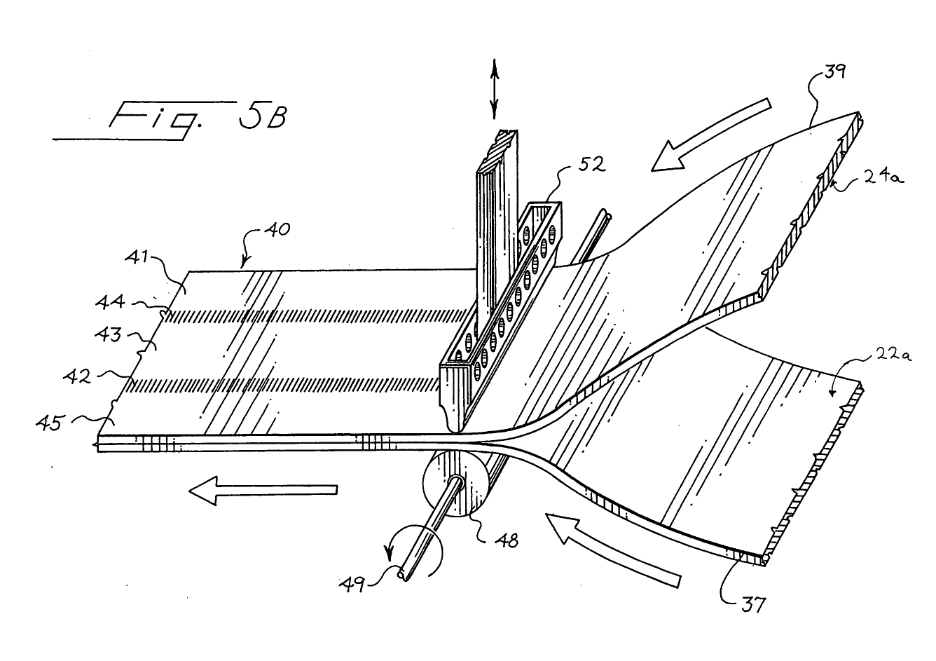

FIGS. 5A and 5B illustrate a portion of an apparatus for manufacturing an ultrasonically welded laminate such as laminate 40. FIG. 5A shows a cylindrical, rotatable anvil 48 rotationally mounted on axle 49. Anvil 48 includes two primary circumferential patterns of raised bars 50 on surface 51 of anvil 48, spaced from the ends of anvil 48. Ultrasonic horn assembly 52 is positioned above and parallel to axle 49 and spaced from surface 51 to define a gap 53 between surface 51 and horn assembly 52. Horn assembly 52 is adapted to vibrate at ultrasonic frequencies such that gap 53 varies in size as horn assembly 52 vibrates. In use, a dual web of thermoplastic sheet materials 37 and 39 is passed between anvil surface 51 and horn assembly 52, in the directions shown by the arrows, as shown in FIG. 5B. Primary patterns of raised bars 50 create bands 42 and 44 of strong ultrasonic welds between the first and second thermoplastic surfaces 22a and 24a of sheet materials 37 and 39, respectively, as anvil 48 rotates and horn assemble 52 vibrates at ultrasonic frequency thereabove.

FIG. 6 illustrates a layout for manufacturing a tabbed container seal of the invention, such as container seal 64. Multilayer laminate of sealing material 60 includes an ultrasonically welded band 62 and non-bonded regions 61 and 63 flanking welded band 62 and running along the length of laminate 60 in the direction of the web movement indicated by the arrow. Ultrasonically welded band 62 is arranged along the approximate center of laminate 60 so that two rows of die-cut container seals 64 can be cut from laminate 60 in a manner such that an ultrasonically welded band 66 extends along one edge portion of each seal 64. Non-bonded regions 61 and 63 flank weld band 62 such that die-cut container seals 64 each include a single non-bonded tab member 68.

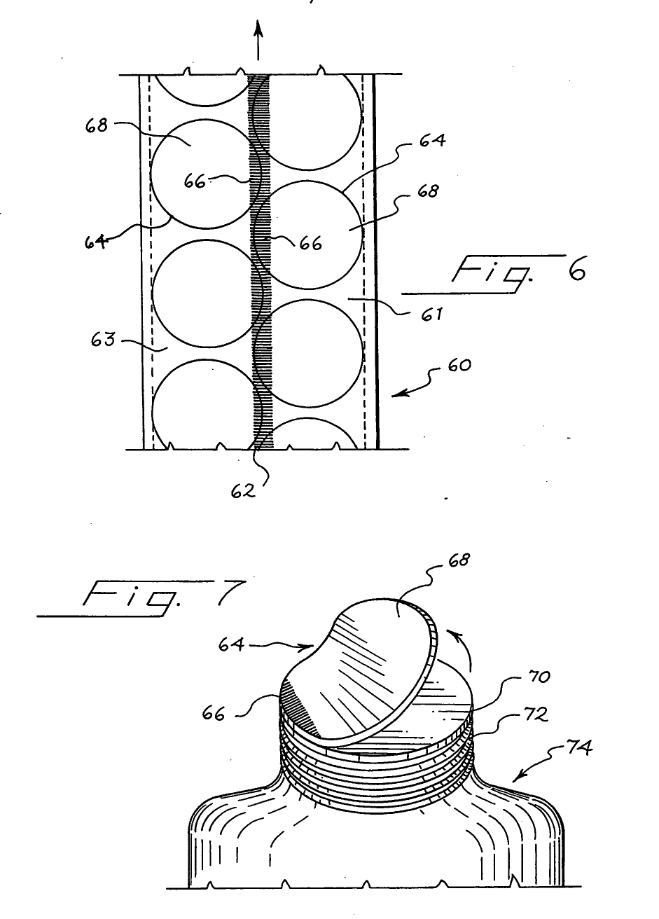

FIG. 7 shows a perspective view of die-cut container seal 64, with tab member 68 lifted away from underlying sealing sheet 70, which is bound to finish 72 of container 74. Preferably the surface area encompassed by ultrasonically welded band 66 comprises about 5 to about 70 percent of the surface area of container seal 64, more preferably about 10 to about 50 percent of the surface area. A consumer can grasp tab member 68 to pull seal 64 from container 74 to access the contents thereof.

FIG. 8 illustrates a layout for manufacturing a tabbed container seal of the invention, such as container seal 84. Multilayer laminate of sealing material 80 includes an ultrasonically welded band 82 and non-bonded regions 81 and 83 flanking band 82 and running along the length of laminate 80 in the direction of the web movement indicated by the arrow. Ultrasonically welded band 82 is arranged along the approximate center of laminate 80 in the direction of web movement indicated by the arrow. Two rows of die-cut container seals 84 can be cut from laminate 80 in a manner such that an ultrasonically welded band 86 extends along about one half of each seal 84 at an edge portion thereof. Non-bonded regions 81 and 83 flank weld band 82 so that die-cut container seals 84 each include a single non-bonded tab member 88.

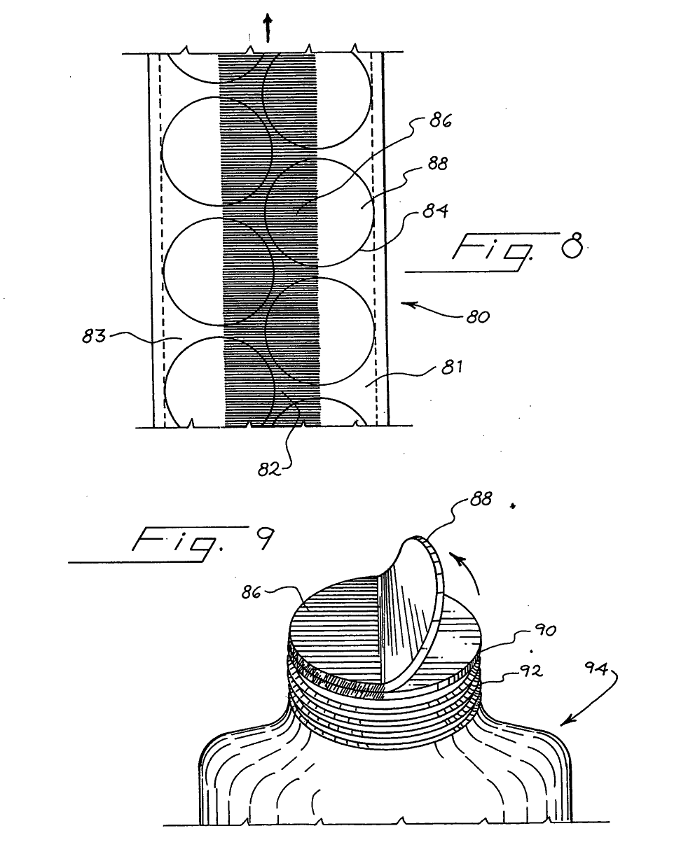

FIG. 9 shows a perspective view of die-cut container seal 84, with tab member 88 lifted away from underlying sealing sheet 90, which is bound to finish 92 of container 94. Preferably the surface area of ultrasonically welded band 86 encompasses about half of the surface area of container seal 84. A consumer can grasp tab member 88 to pull seal 84 from container 94 to access the contents thereof.

FIG. 10 schematically illustrates a preferred tabbed container seal 100, including five layers of material. Container seal 100 comprises sealant layer 102 directly bound to a surface of metal foil layer 104 (e.g., aluminum foil having a thickness in the range of about 0.00035 to about 2 mils, preferably about 1 mil). The other surface of metal foil layer 104 is bound to a surface of thermoplastic film 108 by a layer of adhesive 106. A portion of the other surface of thermoplastic film 108 is bound to an opposed portion of thermoplastic tab sheet 110 by a band of ultrasonic welds 112. Layers 102, 104, 106, and 108 collectively define sealant sheet 101 and non-bonded portions of tab sheet 110 define tab members 113 and 115. Preferably, sealant layer 102 is a heat-sealable polymeric hot melt coating, as described herein. Thermoplastic film 108 and thermoplastic tab sheet 110 are both preferably polyethylene terephthalate (PET) films having a thickness in the range of about 1 to about 5 mils.

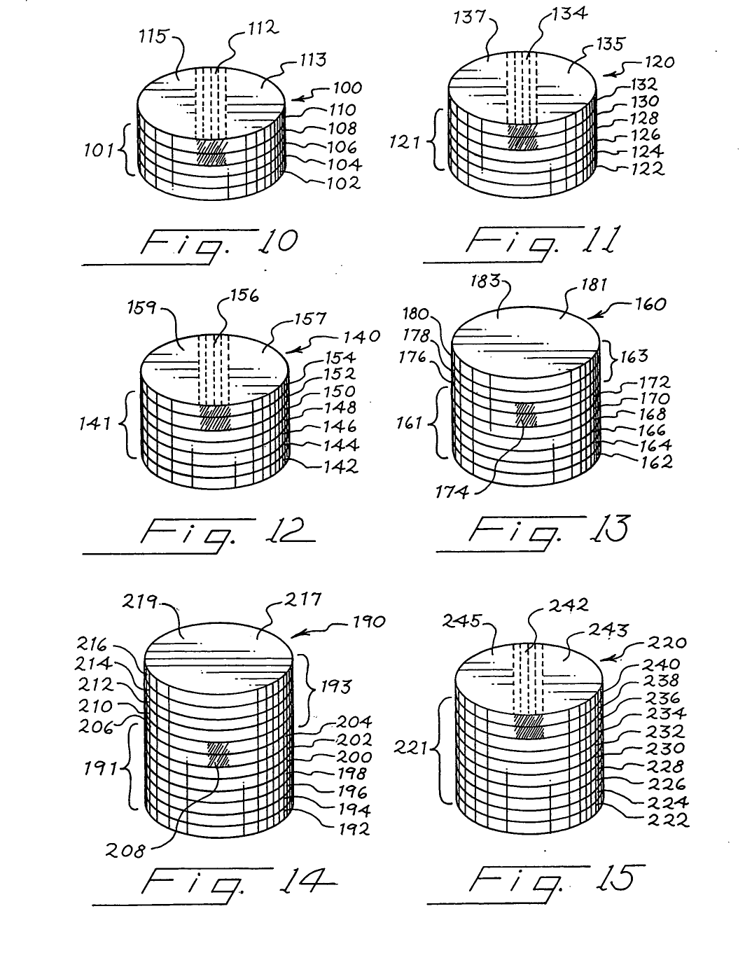

FIG. 11 schematically illustrates a preferred tabbed container seal 120, including six layers of material. Container seal 120 comprises sealant layer 122, which is preferably a heat-sealable polymeric film such as a polyethylene/polypropylene (PE/PP) film, ethylene vinyl acetate (EVA) copolymer film, an ethylene maleic anhydride (EMA) copolymer film, an ionomer film, and the like, bound to a surface of metal foil layer 126 (e.g., aluminum or aluminum alloy foil) by a first layer of adhesive 124. The other surface of metal foil layer 126 is bound to a surface of thermoplastic film 130 by second layer of adhesive 128. A portion of the other surface of thermoplastic film 130 is bound to an opposed portion of thermoplastic tab sheet 132 by an ultrasonically welded band 134. Layers 122, 124, 126, 128, and 130 collectively define sealant sheet 121 of container seal 120 and non-bonded portions of tab sheet 132 define tab members 135 and 137. Preferably, thermoplastic film 130 and thermoplastic tab sheet 132 are both polyethylene terephthalate (PET) films or both nylon-6 films, and have a thickness in the range of about 1 to about 5 mils.

FIG. 12 schematically illustrates a preferred tabbed container seal 140, including seven layers of material. Container seal 140 comprises sealant layer 142 (e.g., a heat-sealable polymer coating) directly bound to one surface of polymeric barrier film layer 144 (e.g., polyethylene, polypropylene, PET, polyvinyl chloride, and the like). The other surface of barrier film layer 144 is bound to a surface of a metal foil layer 148 (e.g., aluminum foil) by a first layer of adhesive 146. The other surface of metal foil layer 148 is bound to a surface of thermoplastic film 152 by a second layer of adhesive 150. A portion of the other surface of thermoplastic film 152 is bound to an opposed portion of thermoplastic tab sheet 154 by an ultrasonic weld zone 156. Layers 142, 144, 146, 148, 150 and 152 collectively define sealant sheet 141 of container seal 140 and non-bonded portions of tab sheet 154 define tab members 157 and 159. Preferably, thermoplastic film 152 and thermoplastic tab sheet 154 are both polyethylene terephthalate (PET) or nylon films.

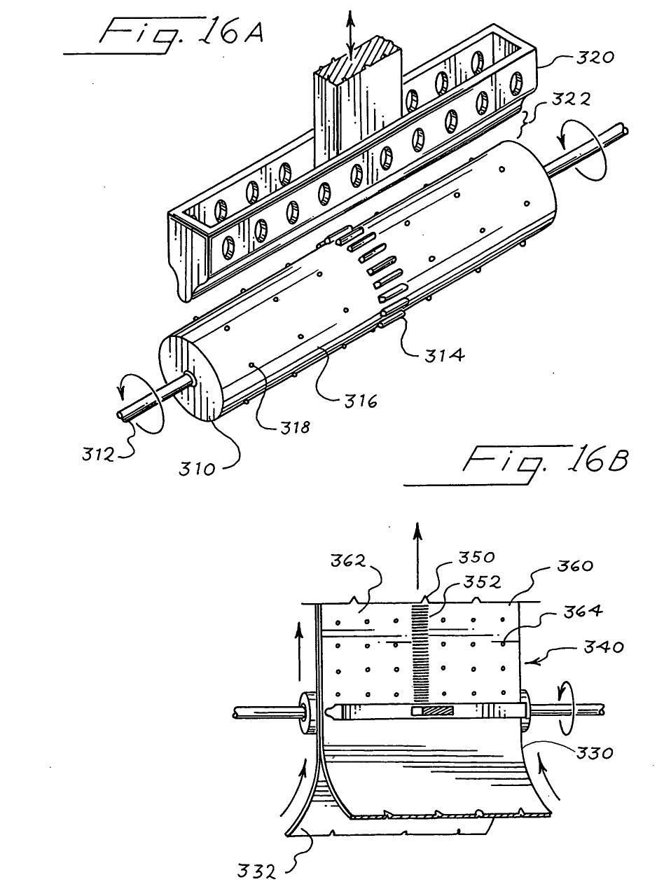

FIG. 13 schematically illustrates a preferred tabbed container seal 160, including nine layers of material. Container seal 160 comprises sealant layer 162 (e.g., a heat-sealable polymeric film) directly bound to one surface of polymeric barrier film 164. The other surface of barrier film layer 164 is bound to a surface of a metal foil layer 168 by a first layer of adhesive 166. The other surface of metal foil layer 168 is bound to a surface of thermoplastic film layer 172 by a second layer of adhesive 170. A portion of the other surface of thermoplastic film layer 172 is bound to an opposed portion of second thermoplastic layer 176 by an ultrasonic weld band 174. The other surface of second thermoplastic layer 176 is bound to an outer surface layer 180 by a third layer of adhesive 178. Barrier film layer 164 preferably is polyethylene, polypropylene, PET, polyvinyl chloride, and the like. Layers 162, 164, 166, 168, 170 and 172 collectively define sealant sheet 161 of container seal 160 and layers 176, 178 and 180 collectively define tab sheet 163. Non-bonded portions of second thermoplastic layer 176 with their overlying layers 178 and 180 define tab members 181 and 183.

FIG. 14 schematically illustrates a preferred tabbed container seal 190, including twelve layers of material. Container seal 190 comprises sealant layer 192 (e.g., a heat sealable polymer film) bound to one surface of polymeric barrier film layer 196 by first layer of adhesive 194. The other surface of barrier film layer 196 is bound to a surface of a metal foil layer 200 (e.g., aluminum foil) by second layer of adhesive 198. The other surface of metal foil layer 200 is bound to a surface of first thermoplastic film layer 204 by a third layer of adhesive 202. A portion of the other surface of first thermoplastic film layer 204 is bound to an opposed portion of second thermoplastic layer 206 by an ultrasonic weld band 208. Preferably thermoplastic film layers 204 and 206 are PET or nylon materials. The other surface of second thermoplastic layer 206 is bound to tab core layer 212 by a fourth layer of adhesive 210 The other surface of tab core layer 212 is bound to a surface of outer layer of sheet material 216 by a fifth layer of adhesive 214. Layers 192, 194, 196, 198, 200, 202, and 204 collectively define sealant sheet 191 of container seal 190 and layers 206, 210, 212, 214, and 216 collectively define tab sheet 193. Non-bonded portions of second thermoplastic layer 206 with their overlying layers 210, 212, 214 and 216 define tab members 217 and 219. Tab core layer 212 can be any flexible sheet material. Preferably, tab core layer 212 is a layer of paper, synthetic fabric, polymeric foam, microporous polymeric film, polymeric extrusion, or the like. Barrier film layer 196 preferably is polyethylene, polypropylene, PET, polyvinyl chloride, and the like.

In one embodiment of container seal 190, core layer 212 is a wax-absorbent layer of paper or synthetic fabric, fifth adhesive layer 214 is a layer of wax, and outer layer 216 is a layer of compressible lining material such as a layer of polymeric foam or pulp board, affording an integrated liner and container seal. In this embodiment, outer layer 216 is releasable from core layer 212 when the wax in fifth adhesive layer 214 is melted and absorbed by core layer 212, such that tab members 217 and 219 consist solely of layers 206, 210, and 212, while layer 216 constitutes a liner.

In another embodiment of container seal 190, core layer 212 is a wax-absorbent layer of paper or synthetic fabric, fourth adhesive layer 210 is a layer of wax, and outer layer 216 is a layer of compressible lining material such as a layer of polymeric foam or pulp board, affording an integrated liner and container seal. In this embodiment, outer layer 216, along with fifth adhesive layer 214 and core layer 212 are releasable from second thermoplastic layer 206 when the wax in fourth adhesive layer 210 is melted and absorbed by core layer 212, such that tab members 217 and 219 consist solely of second thermoplastic layer 206, while layers 212, 214, and 216 together define a liner in this embodiment.

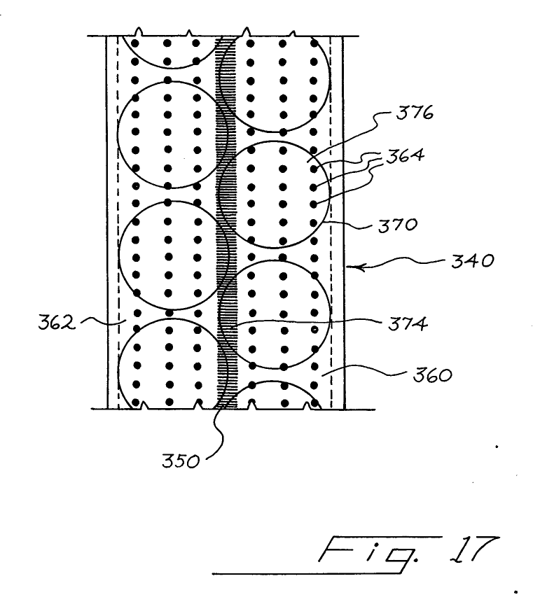

FIG. 15 schematically illustrates a preferred tabbed container seal 220, including ten layers of material. Container seal 220 comprises sealant layer 222 bound to one surface of polymeric barrier film layer 226 by first layer of adhesive 224. The other surface of barrier film layer 226 is bound to a surface of metal foil layer 230 by a second layer of adhesive 228. The other surface of metal foil layer 230 is bound to a surface of backing layer 234 by third layer of adhesive 232. The other surface of backing layer 234 is bound to first thermoplastic layer 238 by fourth layer of adhesive 236. A portion of the other surface of first thermoplastic film layer 238 is bound to an opposed portion of thermoplastic tab sheet 240 by ultrasonic weld band 242. Layers 222, 224, 226, 228, 230, 232, 234, 236, and 238 collectively define sealant sheet 221 of container seal 220, and non-bonded portions of tab sheet 240 define tab members 243 and 245. Preferably, sealant layer 222 is a heat-sealable polymeric film, such as polyethylene/polypropylene copolymer, ethylene vinyl acetate copolymer, and the like. Barrier film layer 226 preferably is polyethylene, polypropylene, PET, polyvinyl chloride, and the like. Backing layer 234 preferably is a cellulose paper, a synthetic paper, a polyolefin film (e.g., TESLIN® film), a polyolefin foam, and the like.

Tabbed container seals of the present invention, having a multilayer tab sheet and/or a multilayer sealant sheet, such as container seals 100, 120, 140, 160, 190, and 220, shown in FIGS. 10-15, can be manufactured by initially ultrasonically welding together sheet materials comprising the thermoplastic surfaces, using a banded ultrasonic welding arrangement such as are shown in FIGS. 4, 6, and 8. After the sheets of thermoplastic materials have been bound together by one or more bands of ultrasonic welds, the other layers of the sealant sheet and the tab sheet can be laminated to and/or coated or extruded on the outer surfaces of the bound thermoplastic materials by conventional lamination and coating techniques that are well known in the art.

In one alternative embodiment, the non-bonded portions of the thermoplastic layers of the container seals described in FIGS. 1-3, 5, 7, and 9-15, or any other tabbed container seal of the invention not specifically shown in the Figures, can be temporarily tacked together by at least one frangible adherent portion, such as by inclusion of a releasable adhesive or an array of relatively weak, frangible ultrasonic or thermal spot-welds in regions flanking the primary, strongly ultrasonically welded portion of the seal. For example, sheets of thermoplastic materials can be tacked together by a releasable adhesive, such as a layer of wax, or a contact adhesive, prior to ultrasonic welding. Alternatively, the portions of the thermoplastic sheet materials flanking the primary, strongly ultrasonically welded portion of the seal can be temporarily tacked together by an array of spaced, frangible ultrasonic spot-welds, which can be generated by a suitable pattern of raised nubs on the anvil at the same time the strong ultrasonically welded band is created. Preferably, such spot-welds are relatively small in size and are spaced from one another, such that the combined surface areas of the spot-welds, themselves, are less than about 5 percent of the surface area of the seal, preferably less than about 1 percent.

For example, FIG. 16A shows a cylindrical, rotatable anvil 310 rotationally mounted on axle 312. Anvil 310 includes a primary pattern of raised bars 314 on surface 316 of anvil 310 to create a primary ultrasonic weld zone and also includes a secondary pattern of nubs 318 on surface 316, which have a lower profile than bars 314 of the primary pattern. Ultrasonic horn assembly 320 is positioned above and parallel to axle 312 and spaced from surface 316 to define a gap 322 between surface 316 and horn assembly 320. Horn assembly 320 is adapted to vibrate at ultrasonic frequencies such that gap 322 varies in size as horn assembly 320 vibrates. In use, a dual web of thermoplastic sheet materials 330 and 332 is passed between anvil surface 316 and horn assembly 320 in the direction of the arrows, as shown in FIG. 16B. Primary pattern of raised bars 314 creates band 350 of strong ultrasonic welds 352 between the sheet materials 330 and 332, so that sheet materials 330 and 332 are bound together to define laminate 340. The lower profile secondary nubs 318 create bands 360 and 362 of frangible spot-welds 364.

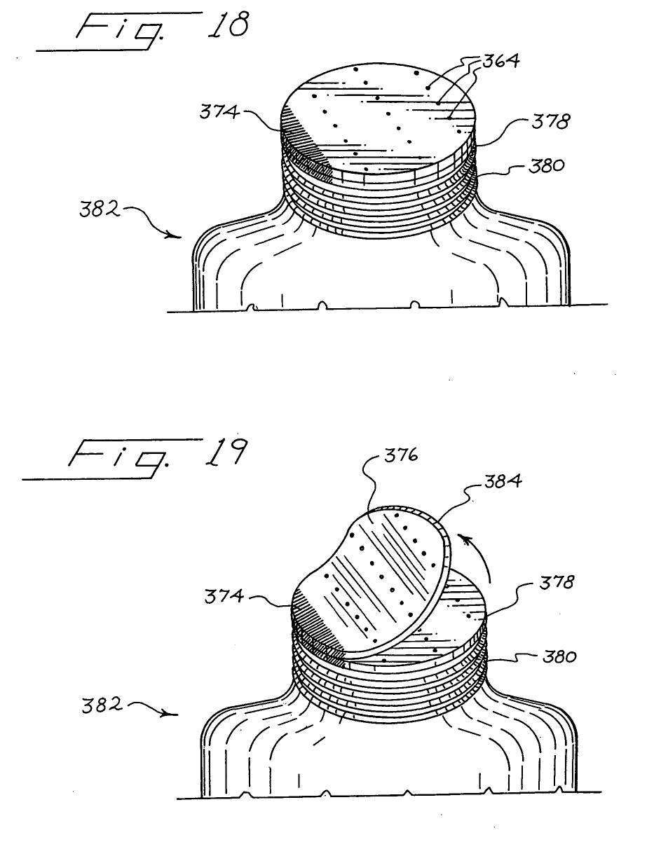

FIG. 17 illustrates that container seals 370 can be die-cut from laminate 340, such that a tab member 376 is formed from band 360 or 362, whereas the ultrasonically welded portion 374 of container seal 370 is formed from primary ultrasonically welded band 350. FIG. 18 shows container seal 370 bonded to finish 380 of container 382. Frangible spot-welds 364 are readily broken by grasping an edge 384 of tab member 376 and lifting it from the surface of the underlying sealant sheet 378, as shown in FIG. 19.

It is to be understood that the positions and sizes of the ultrasonic welds in the container seals of FIGS. 10-15, as well as the number and order of the layers thereof, and the materials comprising the layers are merely illustrative, and are not limiting. In any of the embodiments described herein, the ultrasonic welds can be arranged along an edge portion of the container seal or any where along the surface of the container seal, so long as at least one edge portion of the tab sheet is liftable from the sealant sheet to provide a graspable tab member.

The patterns of the primary ultrasonic weld bands and of the secondary weak weld bands shown in the Figures (e.g., repeating parallel lines, bars and arrays of dots) are an illustration of preferred weld patterns, and are not meant to be limiting. Any desired weld pattern can be used in place of the patterns shown in the Figures, including, but not limited to bands of dot structures, continuous or discontinuous “zig-zag” patterns of bars, dots, crosses, “X” forms, and the like, as is well known in the ultrasonic welding art. Several suitable weld patterns are shown on page 13 of the brochure entitled Ultrasonics Basic Principles and Design Guidelines published by Herrmann Ultraschalltechnik GmbH & Co. KG, Karlsbad, Germany, available on the world wide web (www) at the uniform resource locator (URL) “HerrmannUltraschall” commercial (“.com”) website, the disclosures of which are incorporated herein by reference. Other examples of weld patterns can be found in Chapter XII of Ultrasonic Plastics Assembly published by Branson Sonic Power Co., Danbury, Conn., pp. 89-93 (1979), the disclosures of which are incorporated herein by reference.

The container seals of the present invention can include any combination of single-layer or multilayer sealant sheet, tab member, and liner, as described above. Multilayer sealant sheets, tab members, and liners preferably are two-layer, three-layer, four-layer or five-layer structures. Multilayer structures generally comprise sheets of cellulose pulp, paper, synthetic fabric, polymer film, polymer foam, metal foil, and the like, or any combination thereof, adhesively bonded together, thermally fused, extruded or coated, to form a unitary structure, as is well known in the materials converting and laminating arts.

In one illustrative use, a container seal of the invention can be die-cut to an appropriate size and shape and conveniently placed within a container closure (e.g., a cap) as a single unit. The container seal is sized to fit securely within the closure and is placed in the closure with its sealing surface facing outward. When the container seal includes a liner portion, the liner preferably is bound to the inside top of the closure by an adhesive, such as a hot-melt adhesive. The closure is then secured to the finish of a container (e.g., a bottle or a jar), for example, by torquing a threaded closure onto a threaded finish of a container after the container has been filled with a product. If the container seal is to be sealed to the finish by an adhesive, the adhesive is applied to the container finish before the sealing surface is placed into contact with the finish.

If the sealing surface comprises a heat-sealable polymeric film, no adhesive is required on the finish; rather, heat is applied to the container seal to bond the sealing surface to the container finish. Heat can be applied to the container seal inductively, if at least one of the liner, tab member or sealant sheet includes a metal foil layer, or if the closure is metal. In the inductive heating process, a filled container having a container seal of the invention secured over its access opening is passed through an induction-sealing device in which radio frequency (rf) energy inductively heats the metal foil layer of the seal (or metal closure, as the case may be), preferably to a temperature in the range of about 65 to about 150° C. For a container seal having a heat-releasable liner, the heat from metal foil also liquefies the layer of wax that tacks the liner to the tab member. The wax is then absorbed by a wax-absorbent material in contact with the wax layer, causing the liner to release and separate from tab member. The wax layer that binds the liner to the tab member preferably is selected to have a melting point in the range of about 65 to about 150° C.

Upon removal of the closure by a consumer, the liner remains in the closure, while the sealant sheet, with its integral tab member, remains bound to the finish of the container as a protective seal. The seal is peelably removable by a consumer by grasping the removal tab and pulling the seal off of the container finish after the closure is removed. In other embodiments the liner can be tacked to the tab member by an array of spaced, frangible ultrasonic spot-welds, as described herein. When a consumer removes the closure, the torque force from the rotating lid shears the spot-welds, releasing the liner from the tab member.

Liner components preferably include compressible materials, such as a cellulose pulp material, a polymeric foam, or a polymeric film. Preferred polymeric foams include a polyolefin foam, a substituted polyolefin foam, or a polyurethane foam. Suitable polyolefin foams include foams of polyethylene, polypropylene, ethylene propylene copolymers, and blends thereof. Non-limiting examples of suitable substituted polyolefins include polystyrene foam, polyvinyl chloride foam, and foam rubber. Preferably, the polyolefin foam is a polyethylene foam, more preferably a low-density polyethylene foam.

The liner, when present, preferably has a thickness in the range of about 15 to about 60 mils (thousandths of an inch), and more preferably about 20 to about 40 mils.

Cellulose pulp-based substrates, which are commonly used in closure liners, can be laminated to other materials such as a metal foil, a polymer film, or to a foil/film laminate using conventional lamination techniques that are well known in the art.

Polymeric foams useful in the container seals of the present invention can be secured to other layers of material, such as a metal foil, paper, synthetic fabric, or polymer film, by lamination or by extruding the foam directly onto a web of the other material, or by extruding a polymeric resin onto a web of the polymeric foam, for example. Methods of extruding polymeric foams are well known in the polymer art. For example, methods of producing polymeric foams are described in A. Brent Strong, Plastics Materials and Processing, 2nd Ed., Prentice Hall Inc., Upper Saddle River, N.J., Chapter 17, pp. 589-614 (2000), the disclosure of which is incorporated herein by reference. The polymeric foams can be manufactured using any known foaming process, e.g. by mechanical foaming, chemical foaming, physical foaming, and the like. Preferably, the polymeric foam is formed by chemical foaming with a blowing agent, or gas injection foaming with a nucleating agent including passive nucleating agents (e.g., particulate materials such as talc) or active nucleating agents (e.g., foaming agents). Blowing agents are well known in the polymer arts.

Suitable blowing agents include the following chemicals designated by the U.S. Environmental Protection Agency as suitable replacements for chlorofluorocarbons (CFC's) and hydrochlorofluorocarbons (HCFCs) for use as blowing agents in polyolefin foams: methylene chloride (dichloromethane); 1,1,1,2-tetrafluoroethane (HFC-134a); 1,1,-difluoroethane (HFC-152a); 1,1,1-trifluoro 2,2-dichloroethane (HCFC-123); 1,1,1-trifluoroethane (HFC-143a); 1,1,1,3,3-pentafluoropropane (HFC-245fa); saturated light hydrocarbons (C₃-C₆ hydrocarbons); water; and carbon dioxide.

Other suitable blowing agents include chemical blowing agents such as carbonate and azo type compounds. Such compounds include, without being limited thereto, ammonium carbonate, ammonium bicarbonate, potassium bicarbonate, sodium bicarbonate, diazoaminobenzene, diazoaminotoluene, azodicarbonamide, diazoisobutyronitrile, and the like.

Metal foils useful in the container seals of the present invention can comprise any metal that is suitable for use in a closure liner or container seal, for example, steel foil (including stainless steel foil), tin foil, aluminum foil (including aluminum alloy foils), and the like. Choice of a particular metal will depend on the nature of the material to be included in the container to be sealed by the container seal of the invention, although aluminum foil is the most common conventional metal foil used for induction dealing purposes, and is particularly preferred. Preferably, the metal foil is aluminum foil having a thickness in the range of about 0.5 mil to about 2 mils.

Materials suitable for use as a polymer film in the container seals of the invention include, for example, polyolefins such as polyethylene or polypropylene, polyesters such as PET, functionalized polyolefins such as ethylene vinyl alcohol (EVOH) or ethylene vinyl acetate (EVA) polymers, halogenated polyolefins such as polyvinyl chloride (PVC) or polyvinylidene chloride (PVdC), acrylonitrile methacrylate copolymer films (e.g., BAREX® film, BP Chemicals, Inc., Cleveland, Ohio), and the like. The polymer film can be a single layer of polymer, or a multilayer structure comprising two or more layers of polymer bound together. A particularly preferred polymer film is PET film. Preferably, the polymer film has a thickness in the range of about 0.5 to about 2 mils.

Adhesives suitable for permanently securing various layers of the container seals of the invention to one another include epoxy adhesives, solvent-based cements containing synthetic rubber or a phenolic resin, acrylic adhesives, urethane adhesives, waxes or any other suitable adhesive, or a tie-layer. Tie-layers are often used to provide adhesion between a nonpolar polymer, such as polyethylene, and a polar polymer such as ethylene vinyl alcohol (EVOH). Typically, tie-layers are functionalized polyolefins such as ethylene acrylic acid copolymers, ethylene vinyl acetate copolymers (EVA), and the like, as is well known in the art.

One preferred form of adhesive is a solventless adhesive system, such as MOR-FREE® 403A/C117, available from Rohm & Haas Corp., Springhouse, Pa.). Another preferred adhesive is the two part adhesive available under the trade name ADCOTE® 503 adhesive, from Rohm & Haas Corp, which is a polyester resin used in combination with a curing agent such as Coreactant F, also available from Rohm & Haas Corp. Another suitable adhesive is Airflex 426 form Air Products, Inc. Other preferred adhesives include, for example, solventless adhesive systems, which are available from Rohm & Haas, and H. B. Fuller (e.g., Fuller WD4120 and WD4122). Adhesives useful in a variety of applications are discussed in detail in Arthur H. Landrock, Adhesives Technology Handbook, Noyes Publications, Park Ridge, N.J., (1985), incorporated herein by reference (hereinafter “Landrock”).

Releasable adhesives useful for tacking a liner to the tab member include weakly bonding adhesives, such as pressure-sensitive adhesives, wax and wax-based adhesives, and the like. Intermittent layers of permanent adhesives can also be utilized. Intermittent layers include arrays of adhesive stripes or dots, the stripes or dots being spaced from one another so that the liftable portions of the tab member can be peeled from the sealant sheet without tearing of either material. As noted above, relatively weak spot-welds can be utilized in place of a releasable adhesive to tack a liner to the tab member, if desired.

Pressure sensitive adhesives are discussed at pages 174-175 of Landrock. Such pressure sensitive adhesives include natural rubber adhesives, natural rubber/styrene-butadiene rubber adhesives, polyisobutylene adhesives, butyl rubber adhesives, as well as mixtures of natural rubber with tackifying resins such as rosins, petroleum, and terpenes. Other pressure sensitive adhesives include ethylene/vinyl acetate copolymers tackified with resins or softeners, vinyl ether polymers, silicone rubber and silicone resin adhesives, and the like.

When a pressure sensitive adhesive is used, one surface in contact with the adhesive can include a release coating, so that the adhesive will have a greater affinity for one surface that the other surface with which it is in contact. Release coatings include acrylic acid esters of long-chain fatty alcohols, polyurethanes incorporating long aliphatic chains, cellulose esters, polytetrafluoroethylene, and the like.

If an adhesive is utilized to bond a polymeric foam and/or a polymeric film to another layer of material, the bonding surfaces of the polymer foam or film can be surface-treated to improve adhesion. Suitable surface treatments include, without being limited to, chromic acid etching, corona treatment, oxidizing flame treatment, gas plasma treatment, and the like.

Wax-absorbent materials useful in the present invention include paper, cellulose pulp (e.g., pulp board), or an absorbent synthetic fabric, such as a nonwoven fabric, an absorbent polymeric foam, a porous polymeric film, and the like. The wax-absorbent material can be a single layer of absorbent material, or a multilayer structure comprising two or more layers of absorbent material bound together (e.g, by an adhesive). In any event, the wax-absorbent material is selected to be capable of absorbing a sufficient quantity of the wax to cause the liner to release from the tab member.

The thickness of a wax-absorbent material is selected so that the material will absorb a sufficient amount of a wax layer to allow the liner to release from the tab member when the wax is melted. Preferably, the wax absorbent material has a thickness in the range of about 1 mil to about 12 mils, more preferably about 2 mils to about 10 mils, and most preferably about 2.5 mils to about 6 mils.

Paper, cellulose pulp, and synthetic fabric materials are useful components of the container seals of the invention even when a wax layer is not utilized. In particular, paper and synthetic fabric materials can be used as a facing for the liner or as a facing for the tab member. Printed matter can be present on the facing to provide product identification information, product promotion information, instructions for use of the container contents, and the like, if desired.

Suitable paper and cellulose pulp materials for use in the container seals of the invention include bleached or unbleached Kraft paper, single-layer or multilayer glassine paper, bleached or unbleached cellulose pulp, clay-coated papers, or any other paper or cellulose sheet material commonly used in container seals or liners in the packaging industry.

Synthetic fabrics that are useful in the container seals of the invention include nonwoven polyolefin fabrics and nonwoven polyester fabrics. Suitable nonwoven polyolefin fabrics include nonwoven polyethylene materials, such as a microporous polyethylene film or spunbonded high density polyethylene, as well as nonwoven polypropylene, nonwoven ethylene-propylene copolymer, and nonwoven blends thereof. Suitable nonwoven polyester fabrics include nonwoven polyethylene terephthalate fabrics and spunlaced DACRON® polyester-based fabrics available from E.I. DuPont de Nemours & Co., Inc. of Wilmington, Del. (Dupont), under the trade name SONTARA®. Preferably, the synthetic fabric is an absorbent polyethylene non-woven fabric such as TYVEK® non-woven fabric, available from DuPont, or a microporous polyethylene film sold under the trade name TESLIN® by PPG Industries, Inc., Pittsburgh, Pa.

A wax layer for tacking a liner to a tab sheet or for temporarily tacking the tab member to the sealant sheet preferably comprises paraffin, a microcrystalline wax, a polyethylene wax, a polyisobutylene resin, a butyl rubber resin, a synthetic wax such as an amide wax (e.g., a stearamide, an oleamide, or erucamide), or any combination thereof. More preferably the wax layer comprises paraffin, a microcrystalline wax, or a combination thereof. Most preferably the wax layer comprises a microcrystalline wax. A wax layer can be deposited utilizing an emulsion of a wax material, as described above, suspended in an aqueous medium. A wax layer, when present preferably has a melting point in the range of about 65 to about 150° C. Preferably, a wax layer has a thickness of about 0.2 to about 2 mils, more preferably about 0.5 to about 0.75 mils.

A barrier film, when present, preferably comprises a polymeric material having oxygen barrier, moisture barrier, solvent barrier, or toughness (i.e, puncture resistance) properties, as desired, based on the type of contents that will be included within a container sealed by the container seal of the invention. The barrier film can be a single layer of polymer, or a multilayer structure comprising two or more layers of polymer either directly bound to one another or adhesively secured to each other. Non-limiting examples of materials that can be used as a moisture barrier film include vinyl chloride/vinylidene chloride copolymer (i.e., PVC-PVdC) films marketed by Dow Chemical Company under the trademark SARAN®, polyethylene, oriented polypropylene (OPP), OPP/polyvinyl chloride (PVC) laminates, and OPP/PVC-PVdC laminates. Non-limiting examples of materials that can be used as an oxygen barrier film include PVC-PVdC, PET, PVC-PVdC/PET laminates, acrylonitrile methacrylate copolymer films, PVdC, and OPP/PVC-PVdC laminates. Non-limiting examples of solvent resistant films include PET and polyethylene. Non-limiting examples of puncture resistant films include PET and PVC. Preferred barrier films are PET, PVdC, and acrylonitrile methacrylate copolymer films. Preferably the barrier film has a thickness in the range of about 0.5 to about 3 mils.

A heat-sealable film or coating, when present, is a thermoplastic material that will soften and bond to a container finish with which it is in contact when heated at temperatures achieved during typical induction or conduction sealing operations, under the pressure exerted by the closure on the container seal between the closure and the container finish. Typically the pressure on the container seal is achieved by torquing a closure over the container seal onto a container finish with a torque in the range of about 15 inch-pounds to about 90 inch-pounds. Non-limiting examples of materials that can be used as a heat-sealable film include low-density polyethylene (LDPE), medium density polyethylene (MDPE), polypropylene (PP), ethylene vinyl acetate (EVA), ionomer films, and amorphous PET, including heat-sealable polymeric hot melt coatings, such as an EVA copolymer, a styrene-isoprene-styrene (SIS) copolymer, a styrene-butadiene-styrene (SBS) copolymer, an ethylene ethyl acrylate copolymer (EEA), a polyurethane reactive (PUR) copolymer, and the like. Typically the heat-sealable film is selected to be of the same material as the container finish or of a material that is compatible with the container finish. Accordingly, a polyethylene film would be selected as a heat-sealable film to seal a high-density polyethylene container finish. Similarly, a PET film can be used as the heat-sealable film to seal a PET container finish. Preferably, the heat sealable film is medium density polyethylene, polypropylene, EVA copolymer, or PET. When a relatively strong, puncture-resistant sealant sheet is desired, a tough barrier film can be included over the heat-sealable film.

Thermoplastic materials, many of which are commodity materials are well known in the art. Non-limiting Examples of thermoplastic materials are described in chapter 6 of A. Brent Strong (ed.) Plastics Materials and Processing, Second Edition, Prentice-Hall, Inc., Upper Saddle River, N.J. (2000), chapter 6 of which is incorporated herein by reference. Preferred thermoplastic materials for use as thermoplastic surfaces of the sealing sheet and the tab member include polyesters such as PET, polyamides, such as nylons (e.g., nylon-6), polypropylene, polyethylene, polyethylene copolymers, polyvinyl chloride, blends and alloys thereof, and the like. Particularly preferred thermoplastic materials include PET and nylon-6.

The selection of appropriate shape and dimensions for a container seal to be used with a particular closure and container combination is routine for one of ordinary skill in the packaging art. Typically, the dimensions of the container seal are chosen to be substantially equal to the inside dimensions of the upper surface of the closure, so that the upper surface of the container seal will fit snugly within closure. The thickness of the container seal is selected based on the clearance between the upper inside surface of the closure and the finish of a complementary container. Preferably, the thickness of the container seal is selected so that the container seal is slightly compressed when the material is sealed between the closure and a container finish. Such compression aids in forming a fluid and/or air-tight seal. Container closures are selected to match container finishes of complementary dimensions and design, as is well known in the packaging art.

The container seals of the present invention can be manufactured, in part, using standard coating and lamination techniques that are well known in the art, in combination with ultrasonic welding. For example, a web of substrate material (e.g., pulp board) and a polymer film can be laminated to a sheet of metal foil using one or more conventional adhesives to form a liner sheet. A thermoplastic surface of a sealant sheet material can be ultrasonically welded, in zones, to a thermoplastic surface of a tab member sheet (e.g., a polymer film) to form a multilayer sheet material. The external surface of the tab member sheet can then be laminated to the polymer film surface of the liner sheet by a releasable adhesive, for example, to form a roll of integrated liner and sealing material. In some embodiments, the sealant sheet will be a multilayer laminate, as will the tab member sheet. The resulting roll material can then be die-cut in register with the ultrasonically welded zones to form container seals of the invention having an integrated, releasable liner portion bound to the tab member.

Preferably, the container seal of the invention has an overall thickness in the range of about 8 to about 85 mils, more preferably about 20 to about 40 mils. It is preferred that the liner portion of the material, when present, have a thickness in the range of about 10 to about 40 mils. Preferably, the sealant sheet portion has a total thickness in the range of about 0.5 to about 5 mils, more preferably about 0.5 to about 3 mils.

The container seals of the present invention can be manufactured to full machine width in a master roll form, utilizing standard roll coating and laminating equipment in conjunction with ultrasonic welding apparatus, all of which are well known in the materials converting an processing arts. Typically, the master roll of sheet material is slit to a desired width and shipped to a closure manufacturer. The closure manufacturer, in turn, die-cuts the slit roll in register with the ultrasonically welded zones to the desired size and shape for use in particular container closures. The die-cut container seals are then inserted or pressed into the closure and sealed to a filled container as described above.

Any common closure design suitable for use with a liner or tamper evident seal can be used in conjunction with the container seals of the present invention. Preferred closures include standard, continuous threaded (CT) closures, which are well known in the art. Such closures are described, for example J. L. Heid and Maynard A. Joslyn, Eds. Fundamentals of Food Processing Operations Ingredients, Methods, and Packaging, The AVI Publishing Company, Inc., Westport, Conn. (1967), pp. 649-655.

Numerous variations and modifications of the embodiments described above may be effected without departing from the spirit and scope of the novel features of the invention. No limitations with respect to the specific embodiments illustrated herein are intended or should be inferred.

I claim:

1. A tabbed container seal comprising:
a flexible sealant sheet having a sealing surface and a first thermoplastic surface; and
a flexible tab sheet of the same size and shape as the sealant sheet having an outer surface and a second thermoplastic surface;
the first and second thermoplastic surfaces being in opposed, congruent contact with each other, a portion of the first thermoplastic surface being ultrasonically welded to an opposed portion of the second thermoplastic surface, the ultrasonically welded portions of the thermoplastic surfaces being positioned such that at least one edge portion of the tab sheet is liftable from the sealant sheet, thereby providing at least one tab member for removing the container seal from a container.

2. The container seal of claim 1 wherein the sealing surface of the sealant sheet comprises a layer of heat-sealable polymer.

3. The container seal of claim 1 wherein the sealant sheet is a multilayer laminate and the first thermoplastic surface is a layer of thermoplastic polymer.

4. The container seal of claim 3 wherein the sealing surface of the sealant sheet is a polymer film and at least one core layer is bound between the layer of thermoplastic polymer and the polymer film.

5. The container seal of claim 4 wherein the at least one core layer comprises a layer of metal foil.

6. The container seal of claim 4 wherein the at least one core layer comprises a barrier film.

7. The container seal of claim 6 wherein the barrier film is selected from the group consisting of an oxygen barrier film, a moisture barrier film, a solvent barrier film, and a combination thereof.

8. The container seal of claim 1 wherein the tab sheet is a sheet of thermoplastic polymer.

9. The container seal of claim 1 wherein the tab sheet is a multilayer laminate and the second thermoplastic surface is a layer of thermoplastic polymer.

10. The container seal of claim 9 wherein the tab sheet further comprises an outer surface layer, and optionally, at least one core layer bound between the outer surface layer and the layer of thermoplastic polymer.

11. The container seal of claim 10 wherein the outer surface layer comprises a layer of paper or synthetic fabric.

12. The container seal of claim 10 wherein the outer surface layer comprises a polymer film.

13. The container seal of claim 12 wherein the outer surface layer comprises a layer of compressible polymeric foam or pulp board, and the outer layer is bound to the core layer by a layer of releasable adhesive.

14. The container seal of claim 1 wherein the surface areas of the ultrasonically welded portions of the first and second thermoplastic surfaces encompass at least about 5 percent of the surface area of each thermoplastic surface.

15. The container seal of claim 1 wherein the ultrasonically welded portions of the first and second thermoplastic surfaces are positioned such that two opposed edge portions of the tab sheet are liftable from the sealant sheet, thereby providing two opposed tab members for removing the container seal from a container.

16. The container seal of claim 15 wherein the tab members are of substantially equal size.

17. The container seal of claim 15 wherein the surface areas of the ultrasonically welded portions of the first and second thermoplastic surfaces encompass at least about 10 percent of the surface area of each thermoplastic surface.

18. The container seal of claim 1 wherein the tab member is tacked to the sealant sheet by at least one frangible adherent portion.

19. A tabbed container seal comprising:
a flexible, multilayer laminated sealant sheet having a sealing layer at one surface and a first thermoplastic layer at its other surface; and
a flexible tab sheet of the same size and shape as the sealant sheet and comprising a second thermoplastic layer;
the first and second thermoplastic layers being in opposed, congruent contact with each other, a portion of the first thermoplastic layer being ultrasonically welded to an opposed portion of the second thermoplastic layer, such that at least one edge portion of the tab sheet is liftable from the sealant sheet, thereby providing at least one tab member for removing the container seal from the container.

20. The container seal of claim 19 wherein the sealant sheet includes a metal foil layer bound between the sealing layer and the first thermoplastic layer.

21. The container seal of claim 20 wherein the sealing layer is adhesively bound to a surface of the metal foil layer.

22. The container seal of claim 20 wherein the sealing layer is a coating on a surface of the metal foil layer.

23. The container seal of claim 22 wherein the sealing layer is a heat-sealable coating.

24. The container seal of claim 19 wherein the tab member is a multilayer laminate comprising at least one additional layer of material over the surface of the second thermoplastic layer that is not in contact with the first thermoplastic layer.

25. The container seal of claim 19 wherein the tab member is tacked to the sealant sheet by at least one frangible adherent portion.

26. A method of manufacturing a tabbed container seal comprising:
ultrasonically forming at least one band of ultrasonic welds between a first moving web of flexible thermoplastic sheet material and a second moving web of flexible thermoplastic sheet material, the first and second webs of thermoplastic sheet material moving at substantially the same speed and in the same direction, the band running in the direction in which the first and second webs of thermoplastic sheet materials are moving, thereby producing a flexible multilayer layer sheet material including at least one ultrasonically welded band and a substantially non-bonded band running parallel to the at least one ultrasonically welded band on each side thereof; and
cutting a container seal from the multilayer sheet material in a manner such that a portion of the container seal encompasses a portion of the at least one ultrasonically welded band, and at least one edge portion of the container seal encompasses a portion of a non-bonded band.

27. The method of claim 26 wherein one or more layers of flexible sheet material are laminated to one or both outer surfaces of the flexible multilayer sheet material prior to cutting the container seal from the flexible multilayer sheet material.
